(19) United States
(12) Patent Application Publication
(10) Pub. No.: US 2025/0353298 A1
(43) Pub. Date: Nov. 20, 2025

(54) LIQUID EJECTING APPARATUS

(71) Applicant: BROTHER KOGYO KABUSHIKI KAISHA, Nagoya (JP)

(72) Inventor: Masaki MORI, Nagoya (JP)

(73) Assignee: BROTHER KOGYO KABUSHIKI KAISHA, Nagoya (JP)

(21) Appl. No.: 19/184,803

(22) Filed: Apr. 21, 2025

(30) Foreign Application Priority Data
May 15, 2024 (JP) 2024-079642

(51) Int. Cl. B41J 2/045; B41J 2/14; G06K 15/02

(52) U.S. Cl. CPC B41J 2/04588; B41J 2/04563; B41J 2/04581; B41J 2/04593; B41J 2/14233; G06K 15/1881; B41J 2002/14306; B41J 2002/14419; G06K 2215/101

(57) ABSTRACT

A liquid ejecting apparatus includes: a head configured to eject, to a medium, a first liquid droplet and a second liquid droplet in which size in an ejection direction is longer and volume is greater than in the first liquid droplet; a moving device configured to move the head relative to the medium in a first direction; and a controller. The controller is configured to execute: generation of second print data based on image data, two continuous second liquid droplets being located in the second print data to be further away from each other in the first direction than in first print data which includes information designating the second liquid droplet; and formation of the image on the medium based on the second print data.

### REFERENCE TO RELATED APPLICATIONS

This application claims priority from Japanese Patent Application No. 2024-079642 filed on May 15, 2024. The entire content of the priority application is incorporated herein by reference.

### BACKGROUND ART

A known liquid ejecting apparatus ejects liquid droplets greater than normal large liquid droplets (hereinafter referred to as an “extra-large liquid droplets”) by using a waveform corresponding to two cycles.

### SUMMARY

Note that such an extra-large liquid droplet has a longer length in an ejection direction than the large droplet while the extra-large liquid droplet is flying. Further, since a liquid droplet ejected from a head lands on a medium while the head and the medium are moving relative to each other, the shape of a dot formed by the liquid droplet on the medium becomes long. Here, in a case where long-length dots on the medium are aligned in a short direction orthogonal to a longitudinal direction of the dots, a vacant space in which no liquid droplet is present between adjacent long-length dots might be generated in the vicinity of an end part of each of the long-length dots which are aligned. In a case where such a vacant space exists, the coverage factor of the liquid with respect to the medium decreases, and the optical density (OD value) decreases.

In this regard, an object of the present disclosure is to provide a liquid ejecting apparatus which contributes to reducing the decrease in the optical density in a case where printing is performed by ejecting extra-large liquid droplets.

A liquid ejecting apparatus according to an aspect of the present disclosure includes: a head; a moving device; and a controller. The head includes a nozzle surface in which a plurality of nozzles each configured to eject a first liquid droplet and a second liquid droplet of liquid to a medium are open, the second liquid droplet having a size in an ejection direction longer than a size in the ejection direction of the first liquid droplet and a volume greater than a volume of the first liquid droplet. The moving device is configured to move the head relative to the medium in a first direction crossing the ejection direction. In a case where an image, on a medium, formed by performing printing by first print data which includes information designating the second liquid droplet includes a continuous-dot image, long-length dots each of which is formed of one of a plurality of second liquid droplets, including the second liquid droplet, landed on the medium, and which have a length long in the first direction being continuously disposed in the continuous-dot image in a second direction crossing the first direction, the controller is configured to control the head and the moving device to: generate second print data based on image data such that a landing position of one second liquid droplet on the medium in the second print data is further away from a landing position of the other second liquid droplet on the medium in the first print data, wherein the one second liquid droplet and the other second liquid droplet form the continuous-dot image; and form the image on the medium by causing each of the plurality of nozzles of the head to eject a liquid droplet based on the second print data, while causing the moving device to move the head relative to the medium in the first direction.

According to the liquid ejecting apparatus related to the present disclosure, since the relative positions of the long-length dots aligned in the second direction which is the short direction, can be shifted in the first direction which is the longitudinal direction, the decrease in the optical density in the vicinity of the end part of each of the long-length dots can be reduced.

### BRIEF DESCRIPTION OF DRAWINGS

FIG. 1 is a schematic view of a liquid ejecting apparatus according to the present disclosure.

FIG. 2 is a schematic cross-sectional view depicting the configuration of a head.

FIG. 3 is a block diagram depicting the functional configuration of the liquid ejecting apparatus.

FIG. 4 is a schematic view depicting an example of ejection signals which are input to an actuator to eject various kinds of liquid droplets composed of an ink.

FIG. 5 is a flow chart schematically indicating an example of operation of the liquid ejecting apparatus.

FIG. 6 is a flowchart indicating the contents of the example of operation of FIG. 5 further specifically.

FIG. 7 is a schematic view for describing the operation depicted in FIG. 6, and depicting dots on a medium in a case where printing is performed by using print data generated in respective steps.

FIG. 8 is a flowchart indicating the contents of another example of operation.

FIG. 9 is a schematic view for describing the operation depicted in FIG. 8, and depicts dots on a medium in a case where printing is performed by using print data generated in respective steps.

FIG. 10 is a table depicting the relationship between an increasing ratio of the density of an image and a replacement rate in a first data-generating process, with respect to the temperature rise in the head.

### DESCRIPTION

In the following, an embodiment of a liquid ejecting apparatus according to the present disclosure will be specifically described, with reference to the drawings. In the following, the same or corresponding elements are denoted by the same reference numerals throughout the drawings, and any overlapping descriptions will be omitted.

### Configuration of Liquid Ejecting Apparatus 1

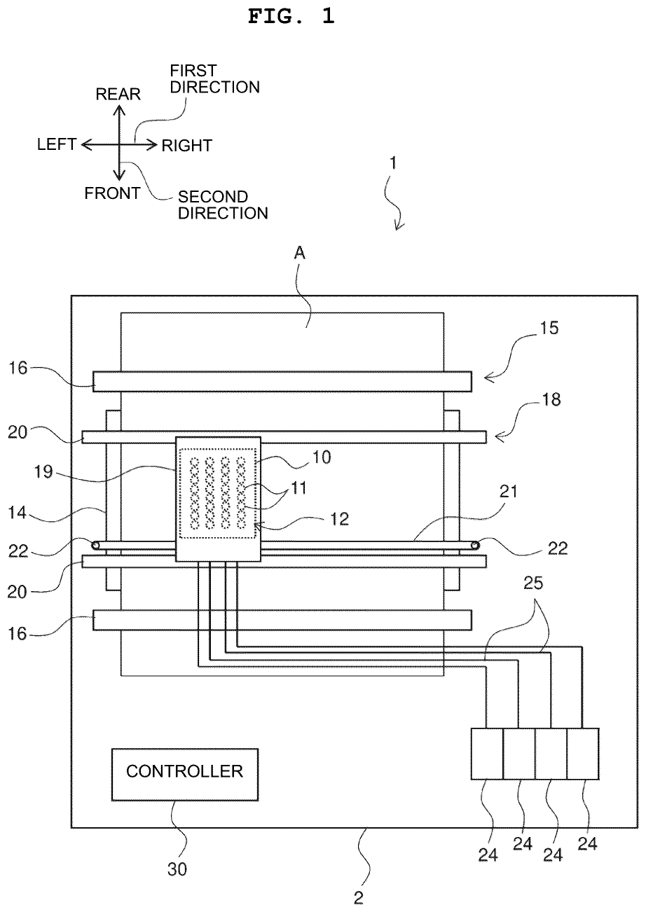

FIG. 1 is a schematic view of a liquid ejecting apparatus 1 according to the present disclosure. The liquid ejecting apparatus 1 is configured to print an image on a medium A with a liquid ejected from a head 10 based on image data. In the following, an example wherein the liquid ejecting apparatus 1 is applied to an ink-jet printer configured to eject an ink will be described.

The liquid ejecting apparatus 1 is based on the serial head system, and alternately performs a step of ejecting inks of a plurality of colors so as to form an image while causing the head 10 to move (scan) and a step of conveying the medium A. Note that in the following description, a direction in which the head 10 reciprocates is referred to as a first direction (or left-right direction), and a conveyance direction of the medium A which is orthogonal to the first direction is referred to as a second direction (or front-rear direction). Further, a direction orthogonal to both the first and second directions is referred to as a third direction (or up-down direction). Note, however, that the direction relating to the placement of the liquid ejecting apparatus 1 is not limited to the above-described directions.

The head 10 is accommodated in a casing 2 of the liquid ejecting apparatus 1. The head 10 has a nozzle surface 12 in which a plurality of nozzles 11 configured to eject the liquid(s) to the medium A based on print data are open. The detailed configuration of the head 10 will be described later.

The liquid ejecting apparatus 1 includes a platen 14 disposed to face the head 10. The platen 14 is positioned below the head 10 at a predetermined distance, and supports the medium A from below by a flat upper surface of the platen 14.

The liquid ejecting apparatus 1 includes a conveyor 15 configured to convey the medium A on the platen 14. The conveyor 15 has, for example, two conveying rollers 16 and a conveying motor. The two conveying rollers 16 are disposed at a distance from each other in the front-rear direction so that the platen 14 is interposed between the two conveying rollers 16, and the two conveying rollers 16 are connected to the rotating shaft of the conveying motor via a reduction gear. Therefore, in a case where the conveying motor is driven, the two conveying rollers 16 rotate about the axes of the two conveying rollers 16, conveying the medium A on the platen 14 in the front-rear direction.

The liquid ejecting apparatus 1 includes a moving device 18 which causes the head 10 to reciprocate in the left-right direction. The moving device 18 has a carriage 19, two guide rails 20, an endless belt 21, and a moving motor. The carriage 19 supports the head 10 and reciprocates together with the head 10 in the left-right direction. The two guide rails 20 extend leftward and rightward across the platen 14 and are disposed separately in the front-rear direction so that the head 10 is interposed between the two guide rails 20. The two guide rails 20 support the carriage 19 so that the carriage 19 is movable (capable of scanning) in the left-right direction.

The endless belt 21 is wound around two pulleys 22 disposed at both the left and right ends of one of the two guide rails 20, and is connected to the carriage 19 at a predetermined location. The moving motor has a rotating shaft connected, via a reduction gear, to a pulley 22, of the two pulleys 22, which is disposed either on the left side or the right side. Therefore, in this moving device 18, in a case where the moving motor is driven and rotated, the endless belt 21 runs, and the carriage 19 supporting the head 10 moves in the left-right direction along the two guide rails 20.

The liquid ejecting apparatus 1 includes a plurality of tanks 24 each configured to store an ink, of the inks of the plurality of colors, which corresponds thereto and which is to be supplied to the head 10. In a case where an openable/closable cover disposed in the casing 2 is opened, the tanks 24 are accommodated in the casing 2. Further, the liquid ejecting apparatus 1 of the present disclosure uses, for example, four color inks, which are cyan, yellow, magenta and black inks, and includes four tanks 24 corresponding to the four color inks, respectively. Furthermore, one end of an elastic tube 25 is connected to each of the four tanks 24, and the other end of the tube 25 is connected to an ink supply port of the head 10, and the ink from each of the four tanks 24 is fed to the head 10 through the tube 25.

Note that as described above, although the liquid ejecting apparatus 1 of the serial head system in which the head 20 reciprocates is described as an example, the present disclosure is also applicable to a liquid ejecting apparatus 1 of the line head system including a head which has a length spanning the entire width of the medium A and which is fixedly disposed (line head). In the case where the liquid ejecting apparatus 1 is based on the line head system, a direction in which the medium A is moved relative to the line head is defined as the first direction.

### Configuration of Head 20

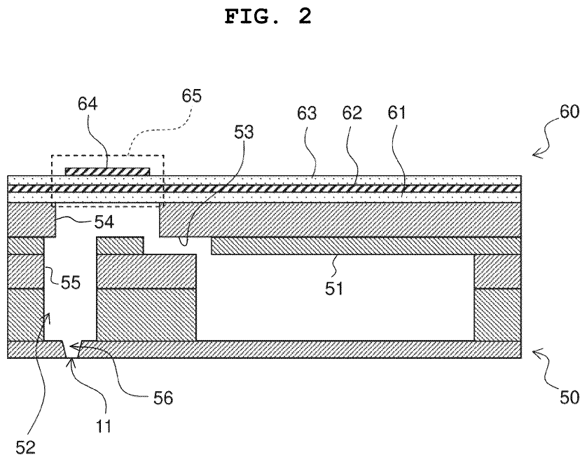

As depicted in FIG. 2, the head 20 has a channel part 50 in which metallic plates such as stainless-steel plates are stacked. Each of the plates is fully etched or half etched, so that a supply manifold 51 and individual channels 52 each communicating with a nozzle 11, of the plurality of nozzles 11, corresponding the individual channels 52 are formed in the channel part 50. Each of the individual channels 52 includes a supply throttle channel 53, a pressure chamber 54, a descender 55, and a nozzle hole 56, and an opening of a lower end of the nozzle hole 56 defines the nozzle 11.

A driving part 60 is stacked on the channel part 50. The driving part 60 has a configuration in which a piezoelectric ceramics layer 61, a common electrode 62, and a piezoelectric ceramics layer 63 are stacked so as to cover substantially the entire area of the upper surface of the head 20, and further a plurality of individual electrodes 64 are disposed so that each of the plurality of individual electrodes 64 corresponds to the pressure chamber 54. A part of the piezoelectric ceramics layer 61, a part of the common electrode 62 and a part of the piezoelectric ceramics layer 63 which correspond to the pressure chamber 54 and an individual electrode 64, of the plurality of individual electrodes 64, corresponding to these parts form each of actuators 65 corresponding to one individual channel 52 of the individual channels 52.

In the head 20 configured as described above, the ink from each of the four tanks 24 is supplied to the supply manifold 51, and the ink is further supplied from the supply manifold 51 to each of the individual channels 52. Ejection pressure is applied to the ink in the pressure chamber 54 of a certain individual channel 52 included in the individual channel 52, by driving (displacement) of an actuator 65, of the actuators 65, corresponding to the certain individual channel. In a case where the ejection pressure is applied, the ink in the certain individual channel 52 moves toward the nozzle hole 56 and is ejected from the nozzle 11 as a liquid droplet.

Note that the above-described configuration of the head 20 is merely an example, and the configuration of the head 20 according to the present disclosure is not limited to the above-described configuration. For example, the head 20 may be configured to have a return manifold, in addition to the supply manifold 51, and may further include a return channel via which the ink is allowed to flow from a downstream end of the descender 55 to the return manifold.

### Functional Configuration by Hardware

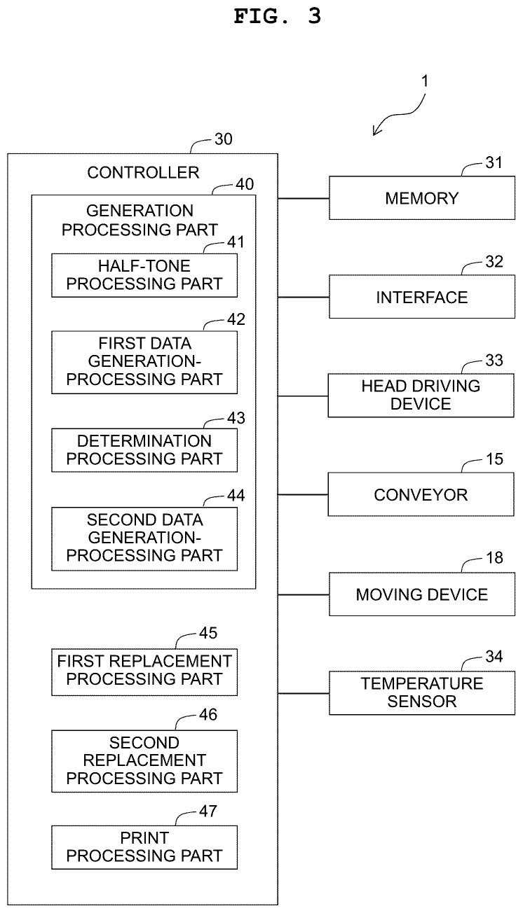

As depicted in FIG. 3, the liquid ejecting apparatus 1 has, as the functional configuration thereof which is mainly constructed of hardware, a controller 30, and a memory 31, an interface 32, a head driving device 33 and a temperature sensor 34 connected to the controller 30. Further, the conveyor 15 and the moving device 18 described above are also connected to the controller 30.

The controller 30 is, for example, a computer, and includes a processor such as an MPU, or a circuit such as an integrated circuit exemplified by an ASIC. The memory 31 is a memory accessible from the controller 30, and has, for example, a RAM and a ROM. The RAM temporarily stores image data included in a print job, first print data and second print data generated from the image data, and various kinds of data to be used during calculation by the controller 30. The ROM stores a computer program and data with which various kinds of data processing are to be performed. Therefore, the controller 30 controls the operations of the respective parts of the liquid ejecting apparatus 1 by executing the computer program while referring to the data stored in the memory 31.

The interface 32 is a connecting device which connects the controller 30 to an external device of the liquid ejecting apparatus 1. Examples of the external device include another computer, a communication network, a storage medium, a display, and another liquid ejecting apparatus. The liquid ejecting apparatus 1 obtains the print job including the image data and print setting information from the external device, such as the computer, via the interface 32.

The head driving device 33 has a head driving circuit electrically connected to the respective actuators 65 of the head 10, and controls the operation of each of the respective actuators 65 based on an instruction from the controller 30. That is, the controller 30 outputs a control signal by which each of the actuators 65 is driven to the head driving circuit, and the head driving circuit generates an ejection signal based on the input control signal and outputs this ejection signal to each of the actuators 65. As a result, each of the actuators 65 is driven based on the ejection signal corresponding thereto. Therefore, the ejection timing of the ink and the size of the ink (volume of the ink droplet) ejected from each of the nozzles 11 can be controlled.

### Ejection Signal and Liquid Droplet

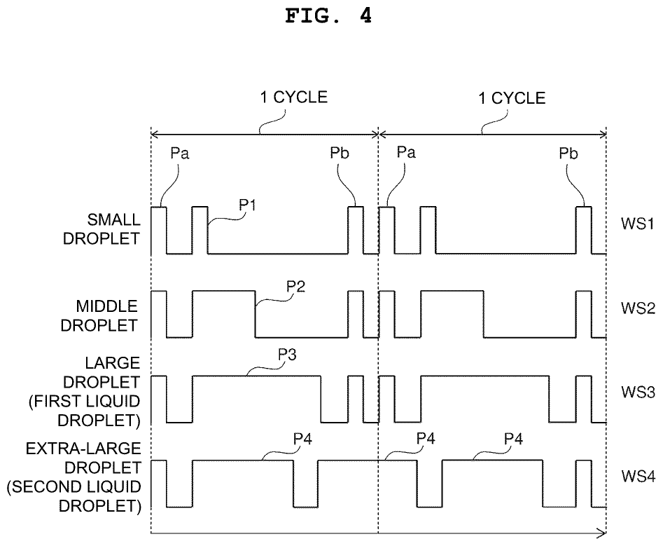

FIG. 4 depicts, in order from the smallest volume, an ejection signal WS1 for a small droplet, an ejection signal WS2 for a medium droplet, an ejection signal WS3 for a large droplet (first liquid droplet), and an ejection signal WS4 for an extra-large droplet (second liquid droplet).

The ejection signal WS1 for the small droplet has a cyclic waveform with one cycle T from a fine movement-pulse Pa to a stabilizing pulse Pb, and an ejection signal corresponding to two cycles is depicted in FIG. 4. Further, the ejection signal WS1 includes an ejecting pulse P1 between the fine movement-pulse Pa and the stabilizing pulse Pb during one cycle T. Here, the fine movement-pulse Pa is a pulse signal which oscillates the meniscus of the ink in the nozzle 11, improves the stability of the ejection of a subsequent liquid droplet and increases the ejection speed of the liquid droplet. The ejecting pulse P1 is a pulse signal which causes the liquid droplet to be ejected from the nozzle 11, and has, for example, a time width close to an integral multiple of the natural cycle of the head 20. Further, the stabilizing pulse Pb is a pulse signal applied after the ejection of the liquid droplet, and is, for example, a pulse having a phase opposite to the phase of the ejecting pulse P1, and stabilizes the meniscus in the nozzle 11.

Similarly to the ejection signal WS1, the ejection signal WS2 for the medium droplet also has an ejecting pulse P2 during one cycle T from a fine movement-pulse Pa to a stabilizing pulse Pb; and the ejection signal WS3 for the large droplet also has an ejecting pulse P3 during one cycle T from a fine movement-pulse Pa to a stabilizing pulse Pb. The pulse width of each of the ejecting pulses increases in the order of the ejecting pulse P1, the ejecting pulse P2, and the ejecting pulse P3. The volume of the ejected liquid droplet differs depending on the difference in the pulse width among the ejecting pulse P1, ejecting pulse P2, and ejecting pulse P3; the greater the pulse width, the greater the volume of the liquid droplet.

Note that, in a case where an attempt is made so as to further increase the volume of the ejected liquid droplet to achieve high duty, a plurality of ejecting pulses (for example, two ejection pulses) need to be inserted during the one cycle T, or to insert an ejecting pulse with a greater pulse width during the one cycle T. However, in a case where the plurality of ejecting pulses are to be inserted, the pulse width of each of the ejecting pulses becomes smaller, and thus the volume of the liquid droplet to be ejected cannot be made great. Further, in a case where an ejecting pulse with a greater pulse width is inserted during the one cycle T, the stabilizing pulse Pb cannot be inserted during one cycle T.

In this regard, in the present disclosure, two cycles (2T) which is twice the normal cycle T are used, and the fine movement-pulse Pa and the stabilizing pulse Pb are inserted, respectively, at the beginning and the end of the two cycles 2T, and a plurality of ejecting pulses P4 (three ejecting pulses P4 in FIG. 4) with a relatively great pulse width are inserted between these pulses Pa and Pb, so as to obtain the ejection signal WS4 for the extra-large droplet (second liquid droplet). In other words, the large droplet (first liquid droplet) is one liquid droplet formed by the waveform corresponding to one cycle (T), and the extra-large droplet (second liquid droplet) is one liquid droplet formed by the waveform corresponding to two cycles (2T). As a result, the second liquid droplet is a liquid droplet in which the size in the ejection direction is longer and in which the volume is greater than in the first liquid droplet.

As described above, the liquid ejecting apparatus 1 of the present disclosure can selectively eject, from each of the nozzles 11, the liquid droplets of various volumes, including the small droplet, the medium droplet, the large droplet and the extra-large droplet. Note that in the above-described description, although the ejection signal WS4 for the extra-large droplet is exemplified as the ejection signal having, as one cycle, substantially the two cycles (2T) which is twice the normal cycle T, the present disclosure is not limited to this. For example, an ejection signal having, as one cycle, substantially three cycles (3T) or more which is thrice or more the normal cycle T, may be used.

As depicted in FIG. 3, the conveyor 15 has a conveyance driving circuit electrically connected to the conveying motor described above, and the operation of the conveying motor is controlled by the controller 30 via the conveyance driving circuit. This allows the conveyor 15 to intermittently or continuously convey the medium A on the platen 14 in the front-rear direction, which is the second direction, and to stop and hold the medium A at a predetermined position on the platen 14.

The moving device 18 has a movement driving circuit electrically connected to the above-mentioned moving motor. The controller 30 controls the operation of the moving motor via the movement driving circuit. This allows the moving device 18 to move the carriage 19 supporting the head 10 in the left-right direction, which is the first direction, at mutually different speeds, and to stop the carriage 19 at any position within the movable range of the carriage 19. Therefore, the head 10 mounted on the carriage 19 is reciprocated by the moving device 18 in the left-right direction relative to the medium A.

The liquid ejecting apparatus 1 causes the head 1 to eject the ink(s) while causing the moving device 18 to move the head 10, thereby forming an image on the medium A for each pass (one pass). That is, the liquid ejecting apparatus 1 causes the conveyor 15 to convey the medium A and causes the conveyor 15 to stop the medium A at a predetermined position on the platen 14, and then the liquid head 1 causes the head 1 to eject the ink(s) while causing the moving device 18 to move the head 10 in the left-right direction, thereby causing the ink to land on the medium A. In this manner, a partial image for one pass is formed on the stopped medium A by the ink(s) ejected while the head 10 is being moved in the left-right direction. Then, in a case where the partial image for the one pass is formed, the liquid ejecting apparatus 1 causes the conveyor 15 to convey the medium A again by a predetermined distance and to stop the medium A, and causes the head 1 to eject the ink(s) to thereby form a partial image for next one pass. The liquid ejecting apparatus 1 alternately repeats the conveyance of the medium A and the ejection of the ink in this manner, thereby printing a whole image constructed of one partial image or a plurality of partial images on the medium A.

The liquid ejecting apparatus 1 further includes the temperature sensor 34. The temperature sensor 34 can adopt a publicly known sensor such as a thermocouple, a thermistor, etc., and the temperature sensor 34 detects the temperature of the head 20 and transmits the value of the detected temperature to the controller 30. In addition to the above-described devices or parts, the liquid ejecting apparatus 1 may also include, as the functional configuration constructed of the hardware, an output device configured to output various kinds of information to the outside, such as a display and a speaker, and an input device configured to receive input of information from the outside, such as a touch panel and a physical switch.

### Functional Configuration by Software

On the other hand, the controller 30 of the liquid ejecting apparatus 1 has, as the functional configuration mainly constructed of software, a generation processing part 40 including a half-tone processing part 41, a first data generation-processing part 42, a determination processing part 43, and a second data generation-processing part 44. The controller 30 of the liquid ejecting apparatus 1 further has a first replacement processing part 45, a second replacement processing part 46, and a print processing part 47. All of these respective processing parts 40 to 47 function in a case where the controller 30 executes the computer program stored in the memory 31.

The half-tone processing part 41 generates half-tone data by performing a half-tone process on the image data which includes the RGB values and which is included in the print job. This half-tone data is print data including information which designates, as the kind of liquid droplet to be ejected from the nozzle 11, any or all of the small droplet, the medium droplet, and the large droplet (first liquid droplet), except for the extra-large droplet (second liquid droplet). The generated half-tone data is stored in the memory 31, for example, until completion of the print job and is erased after the completion of the print job.

The first data generation-processing part 42 executes a first data generating process of generating the first print data based on half-tone data including the designation of the large droplet. This first print data is print data in which at least a part of the designation of the large droplet (first liquid droplet) in the half-tone data is replaced with the designation of the extra-large droplet (second liquid droplet). Such a first data-generating process is performed in a case where a specified condition is satisfied, for example, in a case where a part of the image data in the print job includes a high-duty image of a predetermined value or more. Note that the generated first print data is stored in the memory 31 until the completion of the print job, and is erased after the completion of the print job.

The determination processing part 43 executes a determining process of determining whether a continuous-dot image, which is an image formed of continuous dots, is included in an image on a medium which is to be formed in a case where the printing is performed by the first print data. That is, the first print data includes the designation of the extra-large droplet. In a case where the ink of the extra-large droplet is ejected while the head 20 and the medium A are moved relative to each other in the first direction, a long-length dot which is long in the first direction (hereinafter referred to as a “second dot D2”) is formed on the medium A. This dot is longer in the length in the first direction than a dot (hereinafter, a “first dot D1”) formed on the medium A by the ejection of the ink of the large droplet. A plurality of such second dots D2 are continuously disposed in the second direction crossing the first direction to thereby form a continuous-dot image B1, and the determination processing part 43 determines, in the determining process, whether the continuous-dot image B1 is included.

The second data generation-processing part 44 executes a process of generating the second print data based on the first print data. This second print data is print data in which, in a case where one extra-large droplet and the other extra-large droplet form the continuous dot image B1 in the first print data, the landing position on the medium A of the one extra-large droplet and the landing position on the medium A of the other extra-large droplet are located to be further away from each other in the first direction than in the first print data. Note that the generated second print data is stored in the memory 31, for example, until the completion of the print job, and is erased after the completion of the print job.

The generation processing part 40 of the present disclosure includes the functions of the half-tone processing part 41, the first data generation-processing part 42, the determination processing part 43, and the second data generation-processing part 44. However, the generation processing part 40 may generate the second print data in a case where the first print data contains the continuous-dot image as a result. Therefore, in a case where the second print data is to be generated, actually generating the half-tone data and the first print data is not strictly necessary.

In a case where an image is printed on the medium A by the printing performed by the first print data and where an extra-large droplet is located at an end part in the first direction of the image on the medium A, the first replacement processing part 45 executes a first replacing process of replacing this extra-large droplet with a plurality of large droplets in the first print data. In a case where the extra-large droplet is ejected, a minute liquid droplet (satellite droplet) might be generated immediately after the ejection of the extra-large droplet, in some cases. In this situation, in a case where this satellite droplet adheres to the medium A, the image quality might be reduced. Therefore, the first replacement processing part 45 performs the first replacing process, and thus the adhesion of the satellite droplet on the margin part of the medium A can be avoided and the decrease in the image quality can be reduced.

In a case where an image is printed on the medium A by the printing performed by the first print data and where first placement B2, in which two continuous large droplets and one extra-large droplet are located adjacent to one another along the first direction, is present in the image, the second replacement processing part 46 executes a process of replacing the first placement B2 with second placement B3 in which one extra-large liquid droplet is located between two continuous large droplets. An image which is formed by continuously ejecting the large droplets, such as in the first placement B2, has a lower density than the density of an image formed by extra-large droplets. Therefore, the second replacement processing part 46 replaces the first placement B2 with the second placement B3 as described above, and thus the density of the image can be increased.

The print processing part 47 executes a printing process of causing the nozzles 11 of the ejection head 20 to eject the liquid droplets while causing the moving device 18 to move the head 20 and the medium A relative to each other based on any the print data which is any one of the half-tone data, the first print data and the second print data, to thereby form an image on the medium A.

### First Example of Operation of Liquid Ejecting Apparatus 1

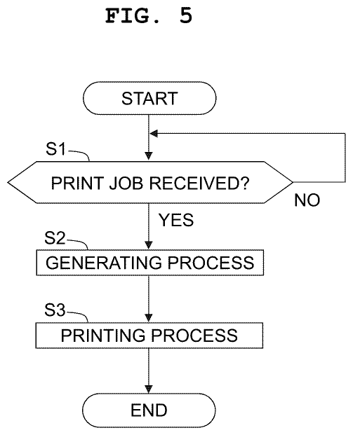

Next, the operation of the liquid ejecting apparatus 1 as described above will be described. As indicated in a flowchart of FIG. 5, the liquid ejecting apparatus 1 determines whether a print job has been received (step S1). In a case where the liquid ejecting apparatus 1 determines that the print job has not been received (step S1: NO), the liquid ejecting apparatus 1 repeats the operation of step S1. On the other hand, in a case where the liquid ejecting apparatus 1 determines that the print job has been received (step S1: YES), the generation processing part 40 executes the generating process to generate the second print data (step S2), and then the print processing part 47 executes the printing process using the second print data (step S3).

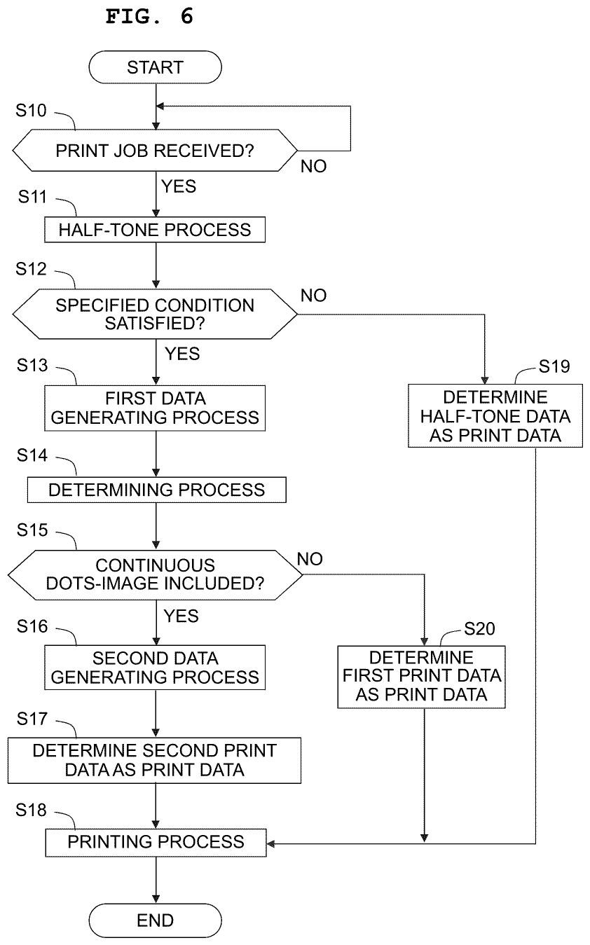

The first example of the operation will be further described with reference to FIG. 6. The liquid ejecting apparatus 1 determines whether the print job has been received, for example, via the interface 32 (step S10). In a case where the liquid ejecting apparatus 1 determines that the print job has not been received (step S10: NO), the liquid ejecting apparatus 1 repeats the operation of step S10. On the other hand, in a case where the liquid ejecting apparatus 1 determines that the print job has been received (step S10: YES), the half-tone processing part 41 executes the half-tone process (step S11) to generate the half-tone data from the image data, and the memory 31 stores the half-tone data.

The liquid ejecting apparatus 1 determines whether the specified condition is satisfied, such as whether the image data contains a high-duty image of the predetermined value or more (step S12). In a case where the liquid ejecting apparatus 1 determines that the specified condition is not satisfied (step S12: NO), the liquid ejecting apparatus 1 determines the half-tone data generated in step S11 as the print data (step S19), and the print processing part 47 executes the printing process (step S18). On the other hand, in a case where the liquid ejecting apparatus 1 determines that the specified condition is satisfied (step S12: YES), the first data generation-processing part 42 executes the first data generating process (step S13).

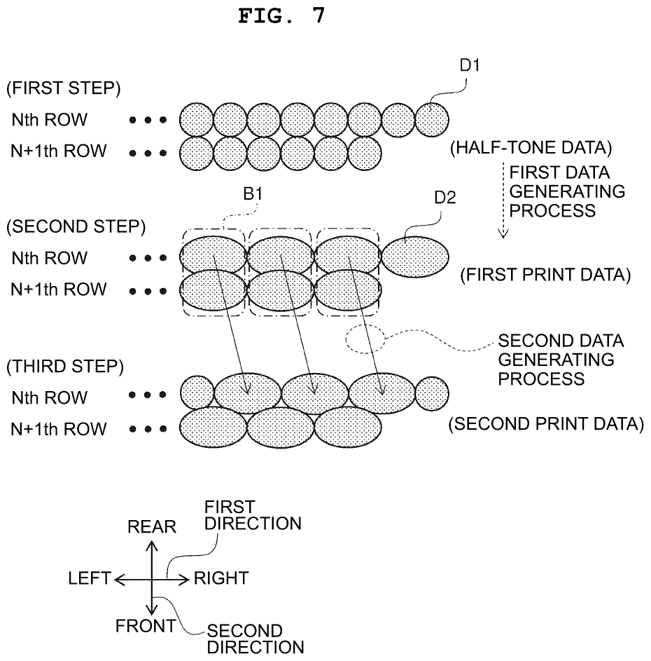

In FIG. 7, alignment of dots along the first direction is referred to as a dot row; among dot rows disposed side by side in the second direction, an Nth dot row is referred to as an Nth row, and an N+1th dot row is referred to an N+1th row. As depicted in a first step of FIG. 7, the half-tone data is data which does not include the designation of the extra-large droplet, and an image printed with the half-tone data is composed of the first dots D1 in both the Nth row and the N+1th row. Although FIG. 7 describes the half-tone data which includes only the designation of the large droplet, the half-tone data may of course include the designation of the small droplet and the medium droplet.

A second step in FIG. 7 depicts a print image by the first print data generated by the first data generating process performed on such half-tone data. In the second step, as appreciated from the comparison between the first step and the second step, two first dots D1 continuous in the first direction in the print image by the half-tone data are replaced with one second dot D2. That is, in the first print data, the designation of the two large droplets which are continuous in the first direction in the half-tone data is replaced with the designation of one extra-large droplet. In the first data-generating process (step S13) in FIG. 6, the designation of such two large droplets is replaced with the designation of one extra-large droplet so as to generate the first print data.

Next, the determination processing part 43 executes the determining process based on the first print data (step S14). That is, the determination processing part 43 determines whether the continuous-dot image B1 is included in the print image by the first print data (step S15). In a case where the determination processing part 43 determines that the continuous-dot image B1 is not included (step S15: NO), the print processing part 47 determines the first print data generated in step S13 as the print data (step S20), and the print processing part 47 executes the printing process (step S18).

On the other hand, in a case where the determination processing part 43 determines that the continuous-dot image B1 is included (step S15: YES), the second data generation-processing part 44 executes the second data generating process (step S16). In the example of FIG. 7, a continuous-dot image B1 in which extra-large droplets are disposed continuously in the second direction, as surrounded by dash-dot lines in the print image depicted in the second step (three continuous-dot images B1 are present in FIG. 7). Therefore, the second data generation-processing part 44 executes the second data generating process (step S16).

Specifically, the second data generation-processing part 44 generates the second print data in which, in a case where one extra-large droplet and the other extra-large droplet form the continuous dot image B1 in the first print data, the landing position on the medium A of one extra-large droplet and the landing positions on the medium A of the other extra-large droplet are located to be further away from each other in the first direction than in the first print data. A third step in FIG. 7 depicts a print image by the second print data generated by the second data generating process. In the case depicted in FIG. 7, as appreciated from the comparison between the second step and the third step, the second print data is generated by shifting extra-large droplet(s) in the Nth row in the first direction by an amount corresponding to the size of one large droplet. In a case where the second print data is generated in this manner in step S16, the print processing part 47 determines the second print data as the print data (step S17), and the print processing part 47 executes the printing process (step S18).

Further, due to the position of the extra-large droplet(s) being shifted in step S16, the position of the end part of the image might shift from the position of the end part in the original image data, in some cases. If such a case arises, the shift in the position of the end part can be reduced by changing a certain liquid droplet which defines the end part of the image to a liquid droplet of which size is different from the size of the certain liquid droplet.

As described above, since the liquid ejecting apparatus 1 of the present disclosure uses the extra-large droplet (second liquid droplet) which has the volume greater than the volume of the large droplet and which forms the long-length dot (second dot D2) which is longer in the length in the first direction on the medium A than in a dot formed on the medium A by the large droplet, the optical density (OD value) of the image can be improved. Further, in a case where the continuous-dot image in which the second dots D2 are aligned in the second direction is included, the printing is performed by the second print data wherein one of the continuous second dots D2 and the other of the continuous second dots D2 are located to be away in the first direction further than in the first print data. With this, the decrease in the OD value in the vicinity of the end part in the first direction in the aligned second dots D2 can be reduced.

Note that in this first example of operation, the time since the liquid droplet ejecting apparatus 1 receives the print job (step S10) and until the print processing part 47 executes the printing process (step S18), the generation processing part 40 performs the generation of the half-tone data (step S11), the generation of the first print data (step S13), and the generation of the second print data (step S16), and each of the generated data is stored in memory 31. Therefore, for example, even after the first print data is generated, there is no need to generate the half-tone data again in a case where the half-tone data is to be used, and the load on the controller 30 can be reduced. Similarly, even after the second print data is generated, there is no need to generate the half-tone data or the first print data again in a case where the half-tone data or the first print data is to be used, and the load on the controller 30 can be reduced.

### Second Example of Operation of Liquid Ejecting Apparatus 1

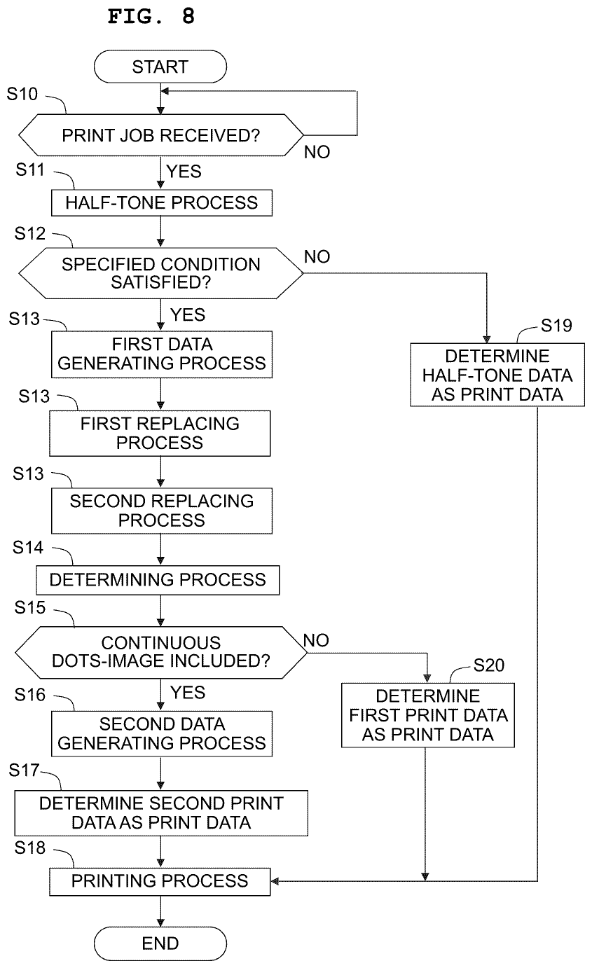

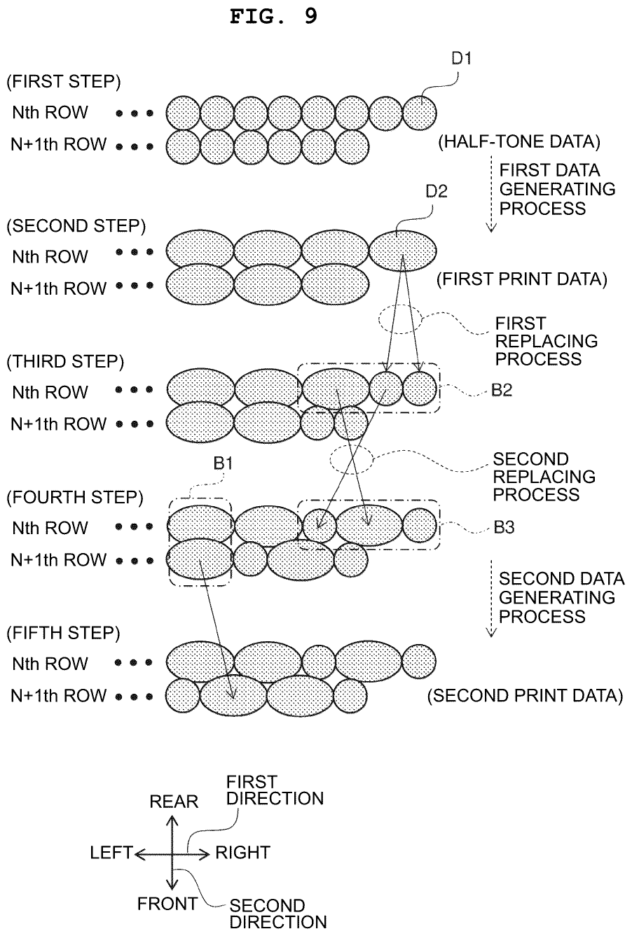

Next, a second example of operation, which is another operation of the liquid ejecting apparatus 1, will be described. The flow chart of FIG. 8 differs from the flow chart of FIG. 6 in that step S13A and step S13B are added to the flow chart of FIG. 8. Also note that the first step and the second step in the schematic view of FIG. 9 are the same as the first step and the second step in the schematic view of FIG. 7. Therefore, the description of the parts in FIG. 8 and FIG. 9 which are the same as the parts in FIG. 6 and FIG. 7 described above will be omitted here.

As depicted in FIG. 8, in the second example of operation, after the first data generation-processing part 42 has executed the first data generating process (step S13), the first replacement processing part 45 executes the first replacing process (step S13A). For example, as depicted in the second step of FIG. 9, in a case where a second dot D2 by the extra-large droplet is located at an end part in the first direction of the print image by the first print data, the first replacement processing part 45 replaces, in the first print data, this extra-large droplet with a plurality of large droplets. As a result, as depicted in the third step of FIG. 9, in an end part of each of the Nth row and the N+1th row in the print image, the (one) second dot D2 formed by the extra-large droplet is replaced with (two) first dots D1 each formed by the large droplet.

Further, in the second example of operation depicted in FIG. 8, after the first replacement processing part 45 has executed the first replacing process (step S13A), the second replacement processing part 46 executes a second replacing process (step S13B). For example, as depicted in the third step of FIG. 9, the print image by the first print data after the first replacing process includes first placement B2 in which two continuous large droplets and one extra-large droplet are disposed adjacent to one another along the first direction. In this case, the second replacement processing part 46 replaces this first placement B2 with second placement B3 in which one extra-large droplet is located between two continuous large droplets. As a result, the alignment of dots in the order of the extra-large droplet, the large droplet, and the large droplet is replaced with alignment of dots in the order of the large droplet, the extra-large droplet, and the large droplet.

In this manner, after the first replacing process (step S13A) and the second replacing process (step S13B) have been executed, the operation of step S14 and the operations thereafter are executed, in a similar manner to the manner described with reference to FIG. 6. As a result, for example, in a case where the second data generation-processing part 44 executes the second data generating process (step S16), as indicated by the change from the fourth step to fifth step in FIG. 9, the second data generation-processing part 44 generates the second print data in which, in a case where one extra-large droplet and the other extra-large droplet form the continuous dot image B1 in the first print data, the landing position of one extra-large droplet and the landing position of the other extra-large droplet are located to be further away from each other in the first direction than in the first print data.

As described above, the second example of operation of the liquid ejecting apparatus 1 of the present disclosure has a similar effect to the effect in the first example of operation. Further, the first replacement processing part 45 executes the first replacing process (step S13A) in the second example of operation, and thus the decrease in the image quality due to a satellite droplet landed on the margin part in a case where an extra-large droplet is ejected to the end part of the image can be reduced. Further, the second replacement processing part 46 executes the second replacing process (step S13B) in the second example of operation, and thus the decrease in the density of the image can be reduced and an image of the high density can be realized.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

The liquid ejecting apparatus 1 described with reference to FIG. 3 includes the temperature sensor 34. In a case where the liquid ejecting apparatus 1 performs the printing continuously, the temperature of the head 10 rises over time since the start of printing, due to the heat generated from each of the actuators 65. In a case where the temperature of the head 10 rises, and even where the waveform of the ejection signal input to each of the actuators 65 is the same, the viscosity of the ink lowers and thus the volume of the ink ejected from each of the nozzles 11 is increased.

Therefore, in order to reduce any unnecessary increase in the density of the image, the first data generation-processing part 42 may change a replacement rate at which two large droplets are replaced with one extra-large droplet in the first data generating process (step S13), depending on the temperature of the head 10.

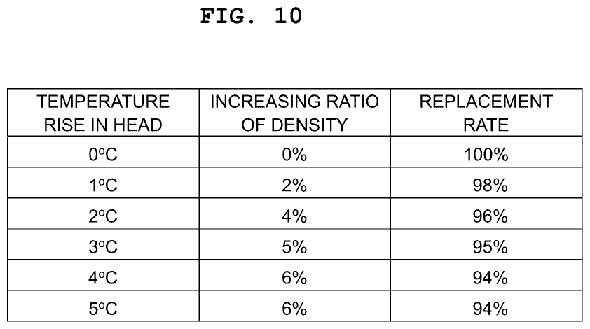

As depicted in FIG. 10, as the temperature of the head 10 rises, the increasing ratio of the density of the image becomes great, and thus the replacement rate is set to gradually decrease. The first data generation-processing part 42 replaces large droplets with an extra-large droplet according to such a setting in the first data-generating process. By doing so, even in a case where the temperature of the head 10 rises, the density before the temperature rise in the head 10 can be maintained.

What is claimed is:

1. A liquid ejecting apparatus comprising:
a head having a nozzle surface in which a plurality of nozzles each configured to eject a first liquid droplet and a second liquid droplet of liquid to a medium are open, the second liquid droplet having a size in an ejection direction longer than a size in the ejection direction of the first liquid droplet and a volume greater than a volume of the first liquid droplet;
a moving device configured to move the head relative to the medium in a first direction crossing the ejection direction; and
a controller, wherein
in a case where an image, on a medium, formed by performing printing by first print data which includes information designating the second liquid droplet includes a continuous-dot image, long-length dots each of which is formed of one of a plurality of second liquid droplets, including the second liquid droplet, landed on the medium, and which have a length long in the first direction being continuously disposed in the continuous-dot image in a second direction crossing the first direction, the controller is configured to control the head and the moving device to:
generate second print data based on image data such that a landing position of one second liquid droplet on the medium in the second print data is further away from a landing position of the other second liquid droplet on the medium in the first print data, wherein the one second liquid droplet and the other second liquid droplet form the continuous-dot image; and
form the image on the medium by causing each of the plurality of nozzles of the head to eject a liquid droplet based on the second print data, while causing the moving device to move the head relative to the medium in the first direction.

2. The liquid ejecting apparatus according to claim 1, wherein
the head includes: individual channels which communicate with the plurality of nozzles, and an actuator configured to be driven by an ejection signal having a periodic waveform so as to apply pressure causing the liquid in the individual channels to be ejected, as the liquid droplet, from the nozzles corresponding to the individual channels,
the first liquid droplet is one liquid droplet formed by a waveform corresponding to one cycle of the ejection signal, and
the second liquid droplet is one liquid droplet formed by a waveform corresponding to two cycles or more of the ejection signal.

3. The liquid ejecting apparatus according to claim 1, wherein
in a case where in the first print data, the second liquid droplet is located at an end part in the first direction of the image, the controller is configured to execute replacement of the second liquid droplet with a plurality of first liquid droplets including the first liquid droplet.

4. The liquid ejecting apparatus according to claim 1, wherein
in a case where first placement in which two continuous first liquid droplets, of a plurality of first liquid droplets including the first liquid droplet and one second liquid droplet of the plurality of second liquid droplets are located adjacent to one another along the first direction of the image is present in the first print data,
the controller is configured to replace the first placement with second placement in which the one second liquid droplet is located between the two continuous first liquid droplets.

5. The liquid ejecting apparatus according to claim 1, wherein
generating the second image data includes:
generating half-tone data based on the image data, the half-tone data including designation of the first liquid droplet and not including designation of the second liquid droplet; and
generating the first print data by replacing at least a part of the designation of the first liquid droplet with the designation of the second liquid droplet based on the half-tone data.

6. The liquid ejecting apparatus according to claim 5, further comprising a temperature sensor configured to detect temperature of the head, wherein
in a case where the controller controls the head and the moving device to generate the first print data, the controller is configured to change a replacement rate of replacing at least the part of the designation of the first liquid droplet with the designation of the second liquid droplet, in accordance with the temperature of the head.
